(19) United States
(12) Patent Application Publication
(10) Pub. No.: US 2008/0288740 A1
(43) Pub. Date: Nov. 20, 2008

(54) Method and Device for Generating an Identification Data Block for a Data Carrier

(75) Inventor: Wolfgang Gaerber, Vienna (AT)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/571,016

(22) PCT Filed: Jun. 28, 2005
(86) PCT No.: PCT/IB2005/052138

§ 371 Date: Dec. 20, 2006

(30) Foreign Application Priority Data
Jun. 30, 2004 (EP) 04103093.3

(51) Int. Cl. G06F 12/06

(52) U.S. Cl. 711/200; 711/E12.078

(57) ABSTRACT

The invention relates to a method for generating an identification data block (ID) for a data carrier (41), which data carrier (41) has a multiplicity of logical data blocks (300) continuously numbered with respective block numbers in a data block size, a reading of the data of the logical data blocks is carried out and the generating of the identification data block (ID) is carried out by means of a combining function from read first data of a logical first data block (301) defined by a first block number and from read second data of a logical second data block (302) defined by a second block number, wherein the logical second data block defined by the second block number is determined in dependence on the read third data of a logical third data block (303) defined by a third block number.

### FIELD OF THE INVENTION

The invention relates to a method for generating an identification data block for a data carrier, which data carrier has a multiplicity of logical data blocks continuously numbered with respective block numbers in a data block size.

The invention further relates to a device for generating an identification data block for a data carrier, which data carrier has a multiplicity of logical data blocks continuously numbered with respective block numbers in a data block size.

The invention further relates to a computer program product that is intended and designed for executing a method according to the opening paragraph given above. The invention further relates to a computer, which computer processes the computer program product according to the above paragraph.

### BACKGROUND OF THE INVENTION

A device as mentioned above and such a computer program product for execution of the above-mentioned method have been brought on the market by the applicants and are therefore known. In the known device and the known computer program product and the known method, an identification data block is generated for a data carrier designed as what is called a Compact-Disc (CD) by linking or a logic operation of identification sub-blocks, which identification sub-blocks are formed from various information items relating to the data stored on the CD, which stored data are organized in sectors in logical data blocks in a data block size. Such an identification data block for a CD is used to facilitate repeated collection or selection of such a CD on a Personal Computer (PC) or a CD-reproduction device. The identification data block is thus characteristic of the CD and as a rule unambiguous and can be used advantageously for example in combination with a suitable remote control device for selecting a CD in a CD-changer reproduction device. By the known method identification data blocks can be generated for such CDs, which data blocks meet a CD-ROM Standard. Mostly only one or two tracks are stored on such a CD, which tracks can contain a multiplicity of files. Such files can contain, for example, audio data compressed by the MPEG1 Layer 3, that is to say MP3-method. In this case, the generation of the identification data block ID is done by linking respectively a logic operation of identification sub-blocks, which are formed from file start times and file names of the contained files, where such identification sub-blocks are also taken into consideration to increase a diversification, which sub-blocks are formed from a total number of files and a total play time of the CD. The file start times are formed from what are called logical block addresses (LBA) of the individual files. It is disadvantageous in this known method that relatively a lot of information or data need to be determined to be able to generate the identification data block ID. Especially disadvantageous is that all the file names of the files contained on a CD must be determined every time and such a determination can cost relatively a long determination time, especially if the CD contains a multiplicity of files. A long determination time has a negative effect on a user-friendly operability of a CD changer reproduction device working with such identification data blocks ID, which is very disadvantageous.

### OBJECT AND SUMMARY OF THE INVENTION

It is an object of the invention to remove the restrictions listed above and to create an improved method according to the method indicated above in the first paragraph and an improved device of the type indicated in the second paragraph and an improved computer program product of the type indicated in the third paragraph, and an improved computer of the type indicated in the fourth paragraph, in which the problems listed above are avoided.

To achieve the above-mentioned object, features as invented are provided in a method as invented, so that a method as invented can be characterized in the manner mentioned below, namely:

Method for generating an identification data block for a data carrier, which data carrier has a multiplicity of logical data blocks continuously numbered with respective block numbers in a data block size, in which method a reading of the data of the logical data blocks is carried out and the generating of the identification data block is carried out by means of a logic operation from first data read of a logical first data block defined by a first block number and from read second data of a logical second data block defined by a second block number, wherein the logical second data block defined by the second block number is determined in dependence on the read third data of a logical third data block defined by a third block number.

To achieve the above-mentioned object, the features as invented are provided for a device as invented, such that a device as invented can be characterized in the manner mentioned below, namely:

Device for generating an identification data block for a data carrier, which data carrier has a multiplicity of logical data blocks in a data block size progressively numbered with respective block numbers, which device comprises the means listed below, namely:

Reading means for reading data of the logical data blocks and generating means for generating the identification data block, by means of which generating means it is possible to generate the identification data block by means of a logic operation from read first data of a first logical data block defined by a first block number and from read second data of a logical second data block defined by a second block number, wherein the logical second data block defined by the second block number is determined in dependence on the read third data of a logical third data block defined by a third block number.

To achieve the above-mentioned object, the features as invented are provided in a computer program product as invented, so that a computer program product as invented can be characterized in the manner mentioned below, namely:

Computer program product, which comprises software code sections and can be loaded directly into the internal memory of a computer, while the method according to the invention can be processed by means of the computer, when the computer program product is processed on the computer.

To achieve the above-mentioned object, the features as invented are provided in a computer as invented, so that a computer as invented can be characterized in the manner mentioned below, namely:

Computer with a processing unit and an internal memory, which computer processes the computer program product according to the invention.

By providing the features as invented, an improved method for generating an identification data block of a data carrier is obtained in a particularly simple manner, wherein an important improvement lies in the fact that only the data of a data carrier stored in a logical data block need be used for generating the identification data block. The advantage compared to the current state of the art is especially obtained through the fact that in a reproduction device of the data carrier, the data of both data blocks of the data carrier can be read out or determined respectively comparatively fast, which is advantageous and noticeable to a user of the reproduction device by its shorter reaction time or response time when operating the reproduction device.

Conventional algorithms are very disc or content-specific methods for generating an identification data block, which makes it difficult to implement the same method for generating an identification data block on different platforms (PC-CDROM/DVDROM-MMC, embedded CD, etcetera). According to the measures as invented, the same method for generating an identification data block is usable on different platforms, which method also provides a desired identification data block relatively quickly, which is very advantageous. In addition, Multi-Session CDs can be clearly distinguished.

In accordance with the measures as claimed in claim 2 and claim 3 and claim 7 and claim 8, unequivocal identification data blocks can be generated advantageously for CDs conforming to the CD-DA Standard (according to the “red book” specification) and for CD-ROMs, on which CD-ROMs a multiplicity of files can be stored in accordance with a file format. Furthermore, the advantage derived is that the generating of the identification data block for CD-ROMs can be undertaken independently of a file system used. Moreover, another advantage derived is that no type information about the CD type used needs to be determined for determining the identification data block, so no determination is needed which CD format is present, which in turn saves time in terms of the reaction time mentioned above.

It has also proved to be very advantageous if the measures as claimed in claim 3 and claim 9 are provided in addition. Unambiguous identification data blocks can thereby be generated for different CD-formats very easily, wherein especially the uniqueness of such an identification data block is ensured for every CD.

It has also proved to be very advantageous if the measures as claimed in claim 0 and claim 6 are provided in addition. This helps achieve an improved diversification of the identification data block.

These and other aspects of the invention are apparent from and will be elucidated, by way of non-limitative example, with reference to the embodiment(s) described hereinafter.

### BRIEF DESCRIPTION OF THE DRAWINGS

In the drawings:

FIG. 1 shows a part, which is important in the present context, of a device according to an example of embodiment of the invention, in a schematic manner in the form of a block circuit diagram.

FIG. 2 shows a flow chart for generating an identification data block by a method as invented.

FIG. 3 shows the logical data blocks of a data carrier used for generating the identification data block.

FIG. 4: A remote control system for selecting data carriers of a reproduction device.

### DESCRIPTION OF EMBODIMENTS

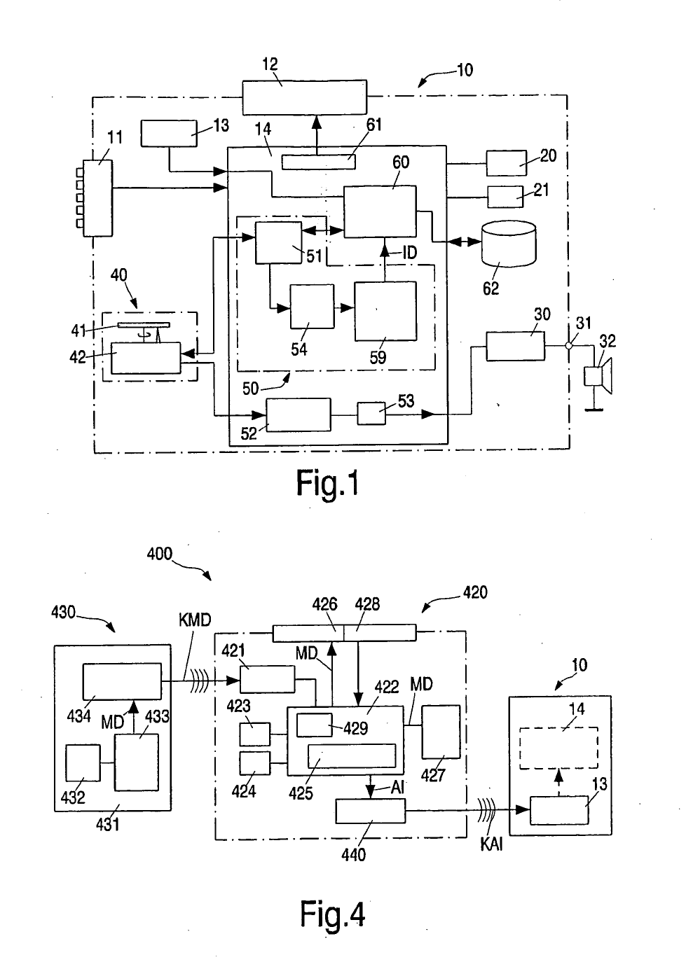

FIG. 1 shows a reproduction device 10 for reproducing a multiplicity of data carriers, which are compact discs (CD) in the present case. The reproduction device 10 has a unit 50 for generating a respective identification data block for such a respective CD. The reproduction device 10 further has a mechanical loading unit for loading multiple CDs, which loading unit is a CD-changer module 40, which CD changer module 40 is, in the present case, configured for loading three (3) CDs as well as optionally positioning one of these CDs in a playing position, only one CD 41 being shown in FIG. 1, which CD 41 is in the playing position. It may be observed that the CD changer module 40 can load still more CDs, for example five (5) or ten (10) or a hundred (100) or only one (1) CD. It should further be mentioned that instead of CDs, they may even be DVDs.

The CD 41 contains digitally stored and optically readable information or data. In the present case, the digitally stored information is stored in accordance with the CD-ROM standard in a file format conforming to the ISO 9660 standard in what are called tracks, which tracks are formed in logical data blocks organized in sectors. The CD-ROM Standard as well as the ISO 9660 standard are widely known in professional circles, so they will not be explained any further here.

The CD changer module 40 contains reading means 42, which reading means 42 are configured for reading out the logical data blocks organized in sectors and in the present case for providing the coded audio data. The reading means 42 are formed in this case by an optical laser-scanning-unit known in professional circles for optical scanning of the CD 41 as well as an associated positioning unit for positioning the laser-scanning-unit.

The reading means 42 are linked to a central processing unit (CPU) 14 contained in the reproduction device 10 and controllable from there.

The central processing unit (CPU) 14 is configured as a microprocessor and is connected to a non-volatile memory ROM 20 and a volatile memory RAM 21, which memories 20 and 21 are intended for known purposes for operating the central processing unit (CPU) 14. The reproduction device 10 further contains input means 11, which input means 11 are in the form of keys, which keys are placed on a casing surface of the reproduction device 10 to be easily accessible to a user of the reproduction device 10 and for inputting the control information, which control information is used for triggering control actions of the reproduction device 10.

Furthermore, there is a remote control sensor 13 contained in the reproduction device 10 and connected to the central processing unit (CPU) 14, which remote control sensor 13 is in the form of an infrared sensor in the present case and is configured for receiving infrared remote control signals in accordance with the RC6 standard. Furthermore, the reproduction device 10 contains pointer means 12 for displaying text and/or image formation for a user. The display means 12 here are an LCD Dot-matrix display, which is placed on a casing surface of the reproduction device 10 so as to be visible to the user. It may be observed that such display means 12 can also be in the form of a VFD display or other similar displays.

Furthermore, there is an amplifier module 30 contained in the reproduction device 10 and connected to the central processing unit (CPU) 14, for amplifying the fed analog audio signals, wherein the analog audio signals amplified by the amplifier module 30 are passed on to the amplifier output 31. There is an audio reproduction means 32 in the form of a loudspeaker at the amplifier output 31, which loudspeaker is configured for reproducing the amplified analog audio signals in the form of sound waves.

The central processing unit (CPU) 14 contains a number of means and modules, which are listed below and which have been enabled to access the RAM 21. Contained therein is a CD module control unit 51, which CD module control unit 51 is connected to the CD changer module 40 and is configured for controlling the CD changer module 40 and the reading means 42. Further contained are sector data block determining means 54, which are connected to the CD module control unit 51 and which are configured for determining identification sub-blocks, which will be explained later. Further contained are logic operation means 59, which are connected to the sector data block determining means 54 and which are provided and configured for generating an identification data block (ID) from the identification sub-blocks. Comparing means 60 are connected to the logic operation means 59 and the CD module control unit 51, which comparing means 60 are configured for comparing identification data blocks (ID) and selection information, which will be explained further. Furthermore, the central processing unit (CPU) 14 contains display driver means 61, by which display driver means 61 data are prepared for text and/or image information for the display means 12. Furthermore, the central processing unit (CPU) 14 contains audio data decoding means 52, which audio data decoding means 52 are connected to the reading means 42 and are configured for decoding the coded audio data outputted by the reading means 42. The decoded audio data received during decoding are passed on to a D/A-converter 53, which D/A converter 53 generates an analog audio signal from the decoded audio data and delivers it to the amplifier module 30.

As already mentioned, the CD changer module 40 is intended and configured for loading or recording three (3) CDs. It is possible to select the CDs contained in the CD changer module 40 very quickly on the basis of generated identification data blocks and subsequently to reproduce them with the help of the advantageous features of the reproduction device 10. The selecting is explained in more detail later on.

The generating of the identification data blocks as invented is described in further detail below, wherein first the basic contexts of stored data are explained with the help of an example CD.

It is assumed that on the initiative of the user of the reproduction device 10, that is to say with the help of the already mentioned control commands, the CD 41, which is regarded as an demo-CD, is placed in the CD changer module 40 in a playing position with the help of the module control commands of the CD module control unit 51. Subsequently, again with the help of the CD module control unit 51 data are read from the data carrier 41 and stored in the RAM 21. The demo-CD contains a data arrangement corresponding to a CD-ROM Standard as listed in Table 1.

TABLE 1

| | Name |
|---|---|
| Session 1 | Session 1 |
| Track 01 | test1.mp3 |
| | test2.mp3 |

The demo-CD thus contains what is called Session S1, which Session S1 contains a data track 01. The data track 01 contains a first file F1 with the file name “test1.mp3” and a second file F2 with the file name “test2.mp3”, which files F1 and F2 contain audio data compressed in accordance with the known MPEG 1 Layer III (MP3-) method. The files are organized corresponding to a file system conforming to the ISO 9660 standard. It may be observed that the data track 01 can similarly have a file system according to another format, for example according to the JOLIET format or the UDF format.

According to the data contained on the demo-CD, what is called a Volume is formed, which Volume consists of a series of logical data blocks, which data blocks are also called sectors and will be called blocks or block for short. The blocks are continuously numbered consecutively starting from zero. According to ISO 9660, the first sixteen (16) blocks in the first data track 01, that is to say blocks zero (0) to fifteen (15), are designated as System Area and can be used manufacturer-specifically. The file system then begins from block sixteen (16), which is defined as Volume Descriptor. Furthermore, according to ISO 9660, the blocks have a logical block size that is counted in bytes, in the present case it being the eleventh power of 2, that is to say 2048 bytes. It may be observed that the block size of the logical blocks can assume other values, for example 512 bytes or 1024 bytes. The respective block size is the same for the entire file system defined by the Volume Descriptor.

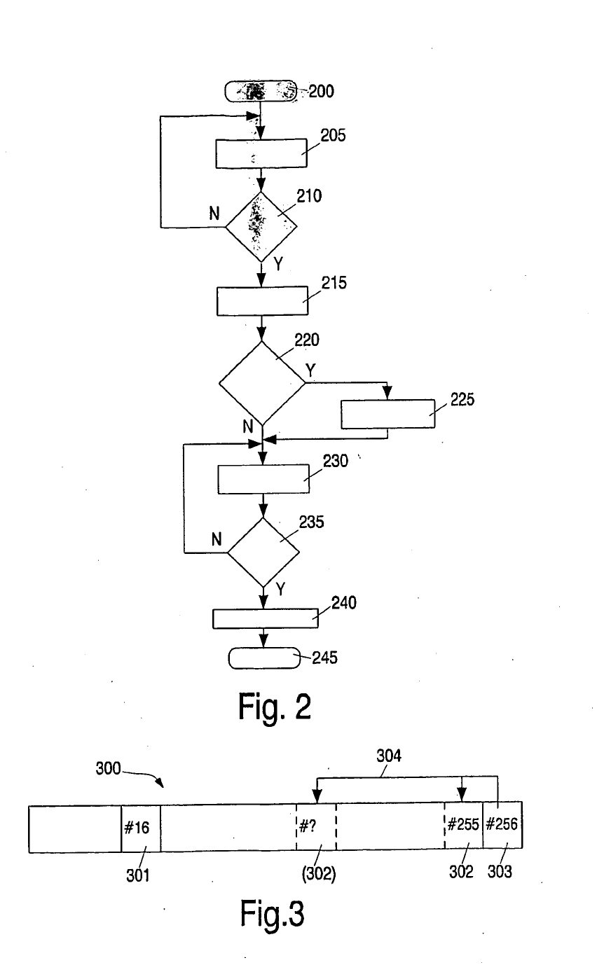

The generating of an identification data block ID for the example CD is explained below with the help of a routine shown in FIG. 2, wherein FIG. 3 is referred to as help, in which FIG. 3 the logical data blocks 300 stored on the example CD are schematically represented. The routine is stored in the form of software code sections in the ROM 20 and is processed with the central processing unit (CPU) 14 when required.

The routine begins with a step 200. In a step 205 the first data of a logical first data block 301 of the CD 41 defined by a first block number are then read, wherein in the present case the data block with the block number #16 (or 0x10 in hexadecimal form) is read. In a subsequent step 210, a query is made whether the reading of the first data block 301 has ended. If this reading has ended, then the routine is continued in the step 215. Otherwise the reading of the first data block 301 is continued in the step 205. As already mentioned, the size of all data blocks—and thus also the size of the first data block 301 as invented—is 2048 bytes in the present case. According to the two steps 205 and 210 a loop is obtained, in which loop this first data block 301 is read iteratively in 512 runs each with a data width of one (1) DWORD (1 DWORD=32 bits=4 bytes) and stored in RAM 21. A first checksum is generated in each loop run from the first checksum obtained from the immediately preceding loop run and an XOR coupling with the currently read DWORD of the first data block. Thus, for example, for the first checksum, a Hex value of 0x002a2356 is obtained.

In the step 215, three data of a logical third data block 303 defined by a logical third block number are determined, wherein in the present case, data of the data block with the block number #256 (or 0x100 in Hexadecimal form) are read. Especially, the value of byte 0x14 of this third data block 303 is read and stored in RAM 21 and subsequently the routine is continued with a step 220. In step 220 there is a check whether the value of byte 0x14 of this third data block 303 is smaller than or equal to the value 0x10. If so, then the routine is continued in a step 225. If not, then the routine is continued in the step 230. In the step 225 the value stored in the RAM 21 of byte 0x14 of this third data block 303 is set to a value 0XFF and the routine is continued with the step 230. In the step 230 the reading of second data of a logical second data block 302 defined by a second block number takes place. In the present case, the second data block 302 is determined by the value of the byte 0x14 of the third block previously stored in RAM 21, as mentioned above. If this value was set to the value 0xFF in accordance with the step 225, then the data block having the block number #255 (or 0xFF in hexadecimal form) is read as second data block, otherwise a data block having another block number (but not smaller than or equal to #16) is read. In FIG. 3 an arrow 304 points out a possible position of the second data block 302. Subsequently, the routine is continued with a step 235, in which step 235 it is checked if the reading of the second data block 302 is already over. According to the steps 230 and 235 in a manner similar to the description of the steps 205 and 210, a second checksum is obtained from the data of the second data block 302. The routine is proceeded now with a step 240, in which step 240 the generating of the identification data block is carried out by means having a logic operation from read first data of a logical first data block 301 defined by a first block number and from read second data of a logical second data block 302 defined by a second block number. In this case, the generating of the identification data block simply follows from an XOR-combination of the first checksum obtained as above with the second checksum. The routine is then ended subsequently with a step 245.

It should be mentioned that the generating of the first checksum may be undertaken only after the second checksum has been generated.

It may be observed that instead of CDs or CD-R or CD-RW, according to the invention a respective identification data block can similarly be generated for Digital Versatile Disks (DVDs), that is to say, for DVDs in their most diverse embodiments such as for example, DVD-Audio, DVD-ROM, DVD+R, DVD-R, DVD+RW etcetera. DVD-Audio for example is specified in several variants and with various memory capacities between 4.7 and 17 GB: DVID-5, DVD-9, DVD-10, DVD-14 and DVD-18 as well as hybrid versions, which hybrid versions or what are called Flip Discs are a sandwich of a conventional audio CD and a DVD audio.

It should further be mentioned that instead of a CD, also semi-conductor memories (Flash-Memory) may be used, for example in the form of memory sticks, Smart Media cards, Compact Flash etcetera.

As soon as the identification data block of the CD is determined, that is to say the CD is recognized, the information combined with this CD can be loaded from a local database 62 contained in the reproduction device 10 and the user of the reproduction device 10 can access this information in the usual manner for playing the pieces of music contained on the CD. More explanation in this respect follows below in connection with FIG. 4.

FIG. 4 shows a remote control system 400 for such an easy choice or selection of MP3 files for the purpose of reproduction of these MP3 files. The remote control system 400 contains a metadata generating device 430 and a remote control device 420 and a reproduction device 10. The reproduction device 10 is configured in accordance with the reproduction device 10 shown in FIG. 1.

The metadata generating device 430 is configured as a computer 431, which computer 431 is configured for processing a computer program product for generating metadata information in respect of at least one data carrier. The computer 431 contains mechanical recording means 432 for recording a disc-shaped data carrier, that is to say in the present case a CD, and for positioning this CD in a playing position. The recording means 432 are connected to metadata generating means 433. The metadata generating means 433 are configured for generating and passing on of metadata MD to transmitting means 434, where the transmitting means 434 are configured for generating coded metadata KMD from the metadata MD as well as for passing on the generated coded metadata KMD. The recording means 432 are in this case in the form of a CD-ROM drive of the computer 431 and correspond mainly to the changer module 40 of the reproduction device 10, where however recording can be done only on one data carrier at a time. The metadata generating means 433 contain modules and means that have already been described above in connection with FIG. 1 for the generating of an identification data block for a data carrier.

A Track/File identification data block FID is generated from a data carrier placed in the recording means 432 of a type described above in connection with FIG. 1, with the help of the read Table of Content TOC of the data carrier. The Track/File-identification data block FID is formed with the help of the start position information of the track or data files. For a track, this is the time information that can be obtained from the Table of Content TOC. For data files, this is the total from the time information of the track, which contains a data file and from time information, which is determined from the logical block address LBA of the data file relative to the logical block address LBA of the track. Time information is calculated or indicated in the time units hours, minutes, seconds and frames, where one (1) byte each is used per time unit and wherein the hours form the most significant byte position and frames the least significant byte position. For a track with a length of 150 Frames, there is for the Track/File-identification data block:

FID(Track01)=TOC(Track01) 150 Frames=00:00:02:00 [hh:mm:ss:ff]=0x200

It may be observed that storage means are present in the metadata generating device 430, which storage means are connected to the metadata generating means 433 and are configured for storing the metadata MD. The storage means may be arranged in the form of a hard disk of the computer 431.

The remote control device 420 is in this case in the form of a Personal Digital Assistant PDA. The remote control device 420 has a central control unit 422, which control unit 422 is configured as microprocessor and is coupled to a non-volatile memory ROM 424 and a volatile memory RAM 423, which memories 424 and 423 are intended and configured for known purposes.

Connected to the central control unit 422 are receiving means 421, which receiving means 421 are configured for receiving and decoding of coded metadata KMD, and storage means 427, which storage means 427 are configured for storage of metadata MD, and display means 426, which display means 426 are configured for displaying metadata MD, and also input means 428, which are configured for inputting input information. In this case the display means 426 and the input means 428 are configured in combination through an LCD Touch screen. The LCD Touch screen works in this case on the resistance principle, where using a stick or the like on the surface of the LCD touch screen can generate the input information. It may be observed that similarly other input means can be provided, for example a keyboard or speech input means.

Metadata processing means 429 are contained in the central control unit 422, by means of which metadata processing means 429 the metadata MD received by the receiving means 421 can be processed and stored in the storage means 427. Other selection information generating means 425 are contained in the central control unit 422, by means of which selection information generating means 425 it is possible to display the metadata MD in the display means 426 and which selection information generating means 425 are configured for generating selection information AI with the help of the inputting means 428. The selection information AI can be passed on to the transmitting means 440, which transmitting means 440 are connected to the central control unit 422. The transmitting means 440 are configured for generating coded selection information KAI from the selection information AI and for passing on the coded selection information KAI, where the coded selection information KAI is in this case in the form of an infrared signal conforming to the RC6 standard, where the RC6 mode 1A—String-type 3 is used. The coded selection information KAI can be transmitted to the receiving means 13 of the reproduction device 10, which receiving means 13 are primarily configured for receiving the coded selection information KAI and secondly for delivering the received coded selection information KAI to the central processing unit (CPU) 14 of the reproduction device 10 for further processing and use of the selection information AI as explained in more detail below.

The metadata MD are stored in the storage means 427 of the remote control device as a metadata list with list entries, which list entries represent the respective tracks or files of a data carrier through the respective metadata MD. It may be observed that means are provided by which the metadata list can be managed, that is to say list entries can be corrected or added or deleted.

With the help of the selection information generating means 425 it is possible to display the metadata MD, wherein the metadata list can be displayed in various views, that is to say the list entries can be sorted according to certain criteria and displayed, for example by name of the interpreter(s), by title, by type or by sorting criteria. If a selection of a list entry is done by an input means, then an associated identification data block Disc-ID and a Track/File-identification data block FID of the list entry is determined and transmitted as selection information to the reproduction device 10 by the transmitting means 440.

In the reproduction device 10, processing of the received selection information AI is done to the extent that it is checked by comparing means 60 whether the determined identification data blocks of data carriers in the CD changer module 40 match the identification data block from the received selection information AI. If there is a match, the track/file identification data block FID received with the identification data block is transmitted to the CD module control unit 51, in which CD module control unit 51, a playback of a track or file of that data carrier is initiated, for which data carrier a matching identification data block is present. On playback in this case the coded audio data are transmitted to the audio data decoding means 52. If no matching identification data block is found, then there is a report by means of a display on the display means 12. It may be observed that a report can be transmitted simultaneously to the remote control device 420, wherein then the reproduction device 10 has transmitting means for transmitting such a report. It may further be observed that the reproduction device 10 can transmit the identification data blocks generated by said transmitting means from the data carriers contained in the CD changer module 40 to the remote control device 10. The remote control device 10 is then configured for receiving and processing such identification data blocks, while a display of the metadata list can comprise only those list entries that have a matching identification data block.

It may further be observed that the reproduction system 400 can be configured for generating and processing of what are called play lists.

1. A method for generating an identification data block (ID) for a data carrier (41), which data carrier (41) has a multiplicity of logical data blocks (300) continuously numbered with respective block numbers in a data block size, in which method a reading of the data of the logical data blocks (300) is carried out and the generating of the identification data block (ID) is carried out by means of a logic operation from first data read of a logical first data block (301) defined by a first block number and from read second data of a logical second data block (302) defined by a second block number, wherein the logical second data block defined by the second block number is determined in dependence on a read third data of a logical third data block (303) defined by a third block number.

2. A method as claimed in claim 1, wherein a Compact Disc is used as a data carrier.

3. A method as claimed in claim 1 wherein the logical data blocks represent a file system and wherein the file system conforms to the ISO 9660 standard or a UDF-standard.

4. A method as claimed in claim 2, wherein the logical first data block (301) determined by the first block number has a block number # 16 and wherein the third data block (303) defined by the third block number has a block number #256 and where the logical second data block (302) defined by the second block number is determined in dependence on a value in the third data block in byte position 0x14.

5. A method as claimed in claim 1, wherein an XOR function is used as a logic operation when the identification data block is generated.

6. A device (10) for generating an identification data block (ID) for a data carrier, which data carrier has a multiplicity of logical data blocks (300) continuously numbered with respective block numbers in a data block size, which device comprises: reading means (40) for reading data of the logical data blocks (300) and generating means (50) for generating the identification data block (ID), by which generating means it is possible to generate the identification data block (ID) by means of a logic operation from read first data of a first logical data block (301) defined by a first block number and from read second data of a logical second data block (302) defined by a second block number, wherein the logical second data block (302) defined by the second block number is determined in dependence on read third data of a logical third data block (303) defined by a third block number.

7. A device (10) as claimed in claim 6, wherein the data carrier is a Compact Disc.

8. A device (10) as claimed in claim 7, wherein the logical data blocks represent a file system and wherein the file system conforms to the ISO 9660 standard or a UDF-standard.

9. A device (10) as claimed in claim 7, wherein, from the generating means (50) for generating the identification data block (ID) the logical first data block (301) determined by the first block number has a block number # 16 and wherein the third data block (303) defined by the third block number has a block number #256 and where the logical second data block (302) defined by the second block number is determined in dependence on a value in the third data block at byte position 0x14.

10. A device (10) as claimed in claim 6, wherein the generating means (50) are configured for generating the identification data block with the help of an XOR operation.

11. A computer program product, that comprises software code sections and can be loaded directly into internal memory of a computer, wherein the method as claimed in claim 1 can be processed by means of the computer, if the computer program product is processed on the computer.

12. A computer program product as claimed in claim 11, wherein it is stored on a computer-readable medium.

13. A computer (430) with a processing unit and an internal memory, which computer (430) processes the computer program product as claimed in claim 11.
